(19) United States
(12) Patent Application Publication
(10) Pub. No.: US 2012/0030682 A1
(43) Pub. Date: Feb. 2, 2012

(54) Dynamic Priority Assessment of Multimedia for Allocation of Recording and Delivery Resources

(75) Inventors: Shmuel Shaffer, Palo Alto, CA (US); Jochen Weppner, Belmont, CA (US); Shantanu Sarkar, San Jose, CA (US); Mukul Jain, San Jose, CA (US); James Bohrer, Seattle, WA (US); Alan D. Gatzke, Bainbridge Island, WA (US); Jim M. Kerr, Seattle, WA (US)

(73) Assignee: CISCO TECHNOLOGY, INC., San Jose, CA (US)

(21) Appl. No.: 12/845,419

(22) Filed: Jul. 28, 2010

(51) Int. Cl. G06F 9/46; G06F 9/50

(52) U.S. Cl. 718/103; 718/104

(57) ABSTRACT

Techniques are provided to allocate resources used for recording multimedia or to retrieve recorded content and deliver it to a recipient. A request associated with multimedia for access to resources is received. A context associated with the multimedia is determined. Resources for the multimedia are allocated based on the context.

### TECHNICAL FIELD

The present disclosure relates to techniques for allocation of resources, such as recording resources, for multimedia or transmission resources for delivery of messages.

### BACKGROUND

Modern conference sessions often involve multimedia, such as audio, video, text documents, graphics, text messaging, etc. It is often desirable to record the multimedia associated with a conference session for later reference. At any given time, recording and storage resources can be limited in certain deployments and applications. The decision as to whether to record the multimedia of one session over the multimedia of another session or to change the characteristics of the recorded data is complex but can have substantial ramifications is not handled properly.

### BRIEF DESCRIPTION OF THE DRAWINGS

FIG. 1 is an example of a block diagram of a system in which multimedia from various sources is allocated with resources based on a context of the multimedia.

FIG. 2 is an example of a block diagram of a resource control server configured to perform a resource allocation control process to allocate resources to multimedia from the various sources.

FIG. 3 is an example of a flow chart for the resource allocation control process.

FIG. 4 is an example of a flow chart depicting examples of a context determination operation performed in the resource allocation control process.

FIG. 5 is a diagram depicting examples of recording resource profiles used by the resource allocation control process.

FIG. 6 is a diagram depicting examples of message preloading resource profiles used by the resource allocation control process.

### DESCRIPTION OF EXAMPLE EMBODIMENTS

### Overview

Techniques are provided herein to allocate resources used for recording multimedia or to deliver a message to an intended recipient. A request associated with multimedia for use of resources is received. A context associated with the multimedia is determined. Resources to be used for the multimedia are allocated based on the context.

### Example Embodiments

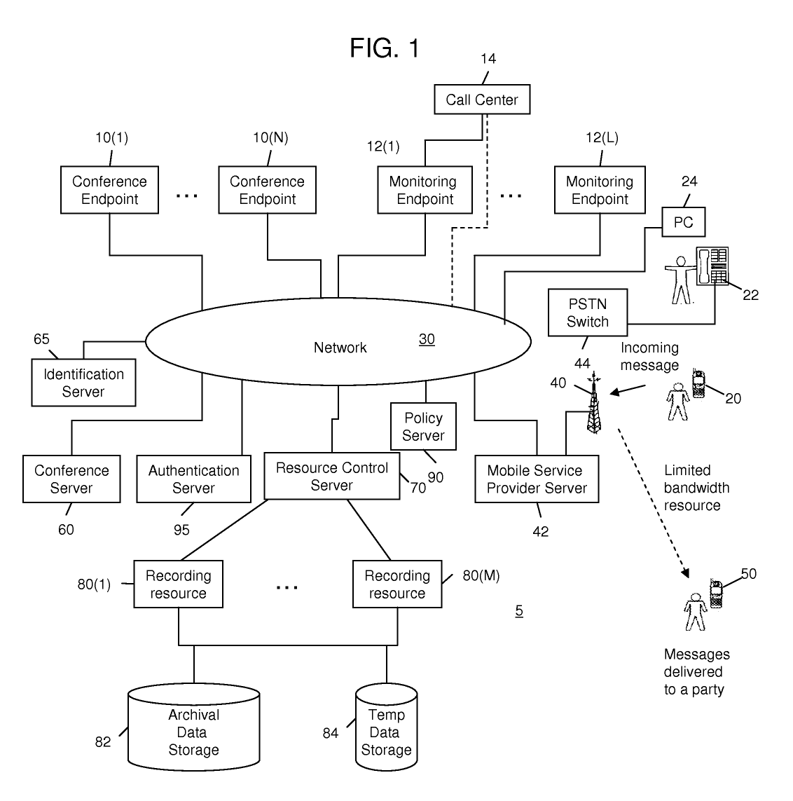

Referring first to FIG. 1, a diagram is shown of a system 5 in which multimedia from various sources is to be allocated with resources that are provided to capture the multimedia for one or more purposes. Examples of sources of multimedia are conference endpoints 10(1)-10(N) from which participants may participate in a conference session. Other sources include monitoring endpoints 12(1)-12(L). Examples of monitoring endpoints 12(1)-12(L) are audio/video (e.g., surveillance) monitoring endpoints comprising a video camera and microphone configured to monitor audio and video at a site of interest. The monitoring endpoints 12(1)-12(L) may also be configured to monitor other media, such as computer inputs from users in a network, text messages between users, on-line chat sessions, call center agent sessions with callers, etc. FIG. 1 shows a call center 14 to which monitoring endpoint 12(1) is connected for this purpose. In another form, the call center 14 is monitored directly without a monitoring endpoint as shown by the dotted line between the call center 14 and the network 30. To this end, the conference endpoints 10(1)-10(N) and monitoring endpoints 12(1)-12(L) have some degree of computing capabilities to collect and encode data representing the activities that they capture or monitor.

Furthermore, FIG. 1 shows that there are several devices that may be sources of incoming multimedia messages, such as a mobile or a remote phone, e.g., Smartphone, 20, landline phone 22 or personal computer (PC) 24.

Each of the sources is connected to a network 30. The network 30 is a telecommunication network that may include a wide area network (WAN), e.g., the Internet, local area networks (LANs), wireless networks, etc. The conference endpoints 10(1)-10(N) and monitoring endpoints 12(1)-12(L) may directly interface to the network 30 using a suitable network interface. The mobile device 20 interfaces to the network 30 via a base station tower 40 of a mobile service provider server 42. The landline phone 22 connects to a Public Switched Telephone Network (PSTN) switch 44 which is in turn connected to the network 30. While not shown in FIG. 1, the landline phone 22 may be a Voice over Internet Protocol (VoIP) phone that connects to a router/access point device which is in turn connected to the network 30. In addition, the PC 24 connects to the network 30 via a suitable network interface and an Internet Service Provider (ISP) not shown in FIG. 1 for simplicity. The mobile device 20, landline phone 22 and PC 24 are devices that may send an incoming message to a destination mobile (remote) device 50 that presents the message to a party (intended recipient) associated with the mobile device 50. This message may contain audio, e.g., a voice mail message, video, text, animation content, or any combination thereof.

Participants at two or more of the conference endpoints 10(1)-10(N) can participate in a conference session. A conference server 60 communicates with the conference endpoints that are part of a conference session to receive multimedia from each conference endpoint involved in the conference session and to transmit back mixed/processed multimedia to each of the conference endpoints involved in the conference session. The conference server 60 is connected to the network 30 and communicates with the conference endpoints 10(1)-10(N) via the network 30. A person at a landline or mobile phone device may also call into a conference session and in so doing would connect to the conference server 60.

There is an identification server 65 that stores and maintains information as to the identities of participants that may participate in a conference session, as well as information on persons that may schedule the conference sessions on behalf of others. For example, the identification server 65 may maintain an on-line corporate identity service that stores corporate identity information for persons at a company and their positions within their organization, e.g., where each person is in the corporate management structure.

The monitoring endpoints 12(1)-12(L) are configured to monitor multimedia associated with a physical location or with activity on devices (e.g., computer devices, call center equipment, etc.). One example of a monitoring endpoint is a video camera (with audio capturing capability) that is oriented to view a particular scene, e.g., a bank or other security sensitive area. In another example, a monitoring endpoint is configured to monitor data entered by a call center agent into a computer screen, conversations with callers, text messages sent by call center agents, on-line chat sessions between parties, etc.

A resource control server 70 is provided that is connected to the network 30 and configured to monitor the utilization of the multimedia recording resources and to manage/allocate use of multimedia recording resources shown at 80(1)-80(M). The recording resources 80(1)-80(M) may have similar or different capabilities with respect to recording of multimedia. Alternatively, two or more of the recording resources may have the same capabilities, i.e., resolution/quality, video versus recording capability, text recording capability, etc. The recording resources are, for example, different recording servers or different services of a single recording server. The recording resources are computing devices that capture the digital multimedia streams from the various sources and convert them to a suitable format for storage. To this end, the resource control server 70 may be integrated as part of a recording server.

Storage of the recorded multimedia is stored in either an archival (more long term) data storage 82 or a temporary (temp) data storage 84. Data storage 82 may be a type of storage useful for long term storage (e.g., tape drive) and which data cannot be readily overwritten. Data storage 84 may be a type of data storage useful for shorter term, e.g., disk drive (but backed up). The resource control server 70 also is configured to allocate transmission resources, e.g., bandwidth, used by the mobile service provider base station 40 and transmit sequence position to preload a message intended for the destination mobile device 50 as described further hereinafter. The radio spectrum needed to send wireless transmissions from the base station 40 to the mobile device 50 is considered a limited bandwidth resource. There is limited amount of bandwidth that a mobile service provider has at any given time to transmit messages or support calls for mobile device users.

A policy server 90 is provided that is connected to the network 30 and configured to store policy information used by the resource control server 70 when determining which of the recording resources 80(1)-80(M) to use for a resource allocation session, e.g., a conference session of one or more conference endpoints 10(1)-10(N), a monitoring session of one or more of the monitoring endpoints 12(1)-12(N) or a message queuing event to determine bandwidth allocation and transmit sequence position of messages intended for the destination mobile device 50. The resource control server 70 and the policy server 90 communicate with each other via the network 30. The resource control server 70 and the mobile service provider server 42 also communicate with each other via the network 30.

An authentication server 95 is provided that is also connected to the network 30. The authentication server 95 handles requests for access to use of the recording resources 80(1)-80(M) and also requests to access to recorded and stored content. The authentication server 95 ensures that access is granted to users determined to be who they represent themselves to be. The identification server 65 and authentication server 95 operate in coordination when handling user requests to utilize resources and user authentication, etc.

The operations of the resource control server 70 and the recording resources 80(1)-80(M) may be integrated into a single server, e.g., a recording server. Moreover, certain operations of the resource control server 70 that pertain to allocating resources for a message to be delivered to the destination mobile device 50 may be integrated into or included as part of the operations of the mobile service provider server 42.

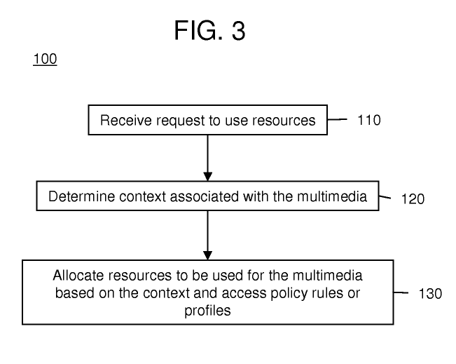

When a conference session is scheduled, by a person who is to participate in that conference session or by another person, and an indication is made that the conference session is to be recorded, the conference server 60 communicates with the resource control server 70 to determine how to record the multimedia associated with the conference session. The resource control server 70 may also perform the functions of the policy server 90 and the authentication server 95 as described above. Similarly, when multimedia originating from a monitoring endpoint is to be recorded, the resource control server 70 determines the nature of the multimedia to be recorded and allocates resources accordingly as described hereinafter. Examples of procedures for determining the assessment made on the context of the conference to determine with which recording resources a conference session is to be recorded are described hereinafter in connection with FIGS. 3-5.

Similarly, examples of procedures for determining allocation of the limited bandwidth resources to play a recorded message, and the order or sequence in which the message is preloaded to the destination mobile device 50 to enable its playback are described hereinafter in connection with FIG. 6.

The term “multimedia” as used herein is meant to refer to one or more of text, audio, still images, animation, video, metadata and interactivity content forms. Thus, during a conference session, participants may speak to each other, see video of each other (contemporaneous with the voice audio), share documents or forms, share digital photograph images, text each other, conduct on-line chats, present animation content, etc.

When the multimedia streams from the conference endpoints involved in a conference session reach the conference server 60 and resource control server 70, they are in digital form and may be encoded in accordance with an encoding format depending on type of media Likewise, the multimedia streams generated by the monitoring endpoints 12(1)-12(L) are in digital form and may be encoded in accordance with an encoding format depending on type of media. The resource control server 70 determines how those digital streams are handled for recording and storage. Even though the multimedia from the conference session is described as being sent via the conference server 60 those skilled in the art will appreciate that the multimedia can be sent directly to the other endpoints while the conference server 60 functions only as a controlling element.

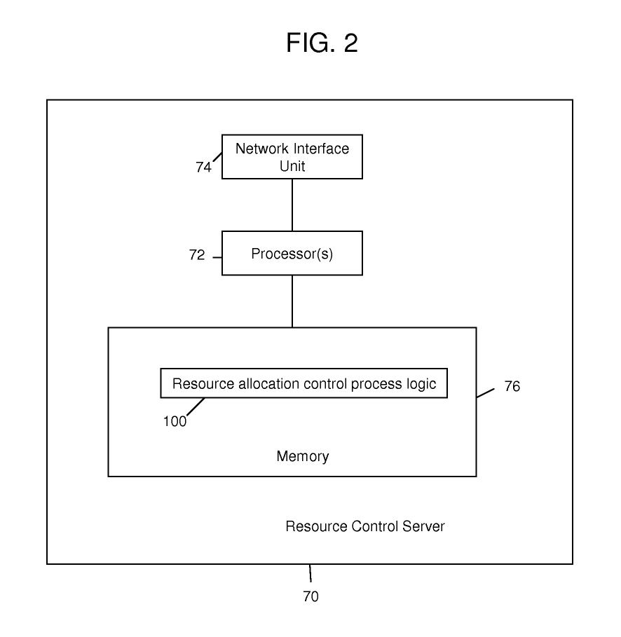

Reference is now made to FIG. 2 for a description of an example of a block diagram of the resource control server 70. The resource control server 70 comprises one or more processors 72, a network interface unit 74 and memory 76. The memory 76 is, for example, random access memory (RAM), but may comprise electrically erasable programmable read only memory (EEPROM) or other computer readable memory in which computer software may be stored or encoded for execution by the processor 72. At least some portion of the memory 76 is also writable to allow for storage of data generated during the course of the operations described herein. The network interface unit 74 transmits and receives data via network 30. The processor 72 is configured to execute instructions stored in the memory 76 for carrying out the various techniques described herein. In particular, the processor 72 is configured to execute program logic instructions (i.e., software) stored in memory 76 for resource allocation control process logic 100. Generally, the resource allocation control process logic 100 is configured to cause the processor 72 to receive a request for use of resources for multimedia, determine a context of the request and allocate resources for the request based on the context.

The operations of processor 72 may be implemented by logic encoded in one or more tangible media (e.g., embedded logic such as an application specific integrated circuit, digital signal processor instructions, software that is executed by a processor, etc), wherein memory 76 stores data used for the operations described herein and stores software or processor executable instructions that are executed to carry out the operations described herein. The resource allocation control process logic 100 may take any of a variety of forms, so as to be encoded in one or more tangible media for execution, such as fixed logic or programmable logic (e.g. software/computer instructions executed by a processor) and the processor 72 may be an application specific integrated circuit (ASIC) that comprises fixed digital logic, or a combination thereof. For example, the processor 72 may be embodied by digital logic gates in a fixed or programmable digital logic integrated circuit, which digital logic gates are configured to perform the operations of the process logic 100. In one form, the resource allocation control process logic 100 is embodied in a processor or computer-readable memory medium (memory 76) that is encoded with instructions for execution by a processor (e.g. a processor 72) that, when executed by the processor, are operable to cause the processor to perform the operations described herein in connection with process logic 100. Memory 76 may also buffer multimedia (voice, video, data, texting) streams arriving from the various endpoints as they are being transitioned into the recording resources 80(1)-80(M) and ultimately to the data storage 82 or 84. The multimedia to be recorded does not travel through the resource control server as it acts mainly as a resource control. For example, in Voice-over-Internet Protocol (VoIP) systems, media and control signals do not take the same path; the media travels endpoint to endpoint rather than to the resource control server 70.

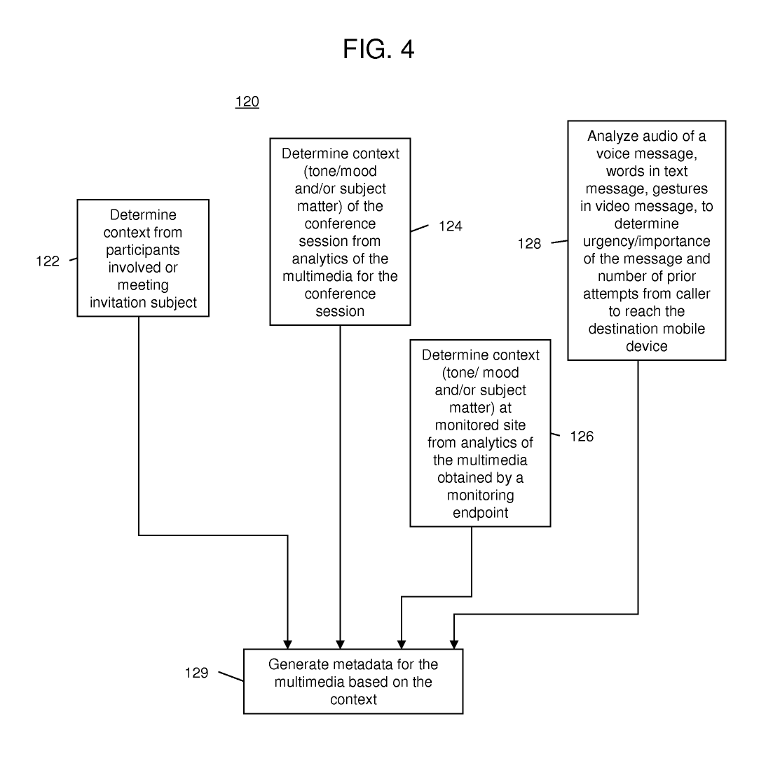

Reference is now made to FIG. 3. FIG. 3 is an example of a flow chart depicting operations of the resource allocation control process logic 100. Reference is also made to FIG. 1 in the following description of FIG. 3. The process logic 100 is configured to dynamically determine, based on a context of a request how much of the available resources (capture, storage, network bandwidth, metadata generation, etc.) are to be allocated and guaranteed to a session. Examples of the “context” include participants involved in a conference session and the topics of the conference session. Other examples of a “context” are described hereinafter in connection with FIG. 4.

At 110, a request is received associated with multimedia to use resources. In the case of a conference session, the request may be received at the resource control server 70 either directly from a meeting participant or person scheduling a meeting, or via the conference server 60. In the case of a monitoring session associated with a monitoring endpoint, the request may originate from a network or system administrator that is configuring a monitoring endpoint to have its monitored media recorded. In the case of the request in connection with a message to be delivered to the destination mobile device, the request may be forwarded to the resource control server 70 from the mobile service provider server 42, or the mobile service provider server 42 may process the request itself according to the operations described herein when the mobile service provider server 42 is configured to perform the operations of process logic 100. In the case of the multimedia originating from a call center 14 where one or more sessions of call center agents are to be recorded, the request to record a session may come from the call center 14.

At 120, a context associated with the multimedia is determined. The context is any information that indicates relative “priority” characteristics of the multimedia to be recorded (or in the case of the message, the urgency of the message to be delivered). These characteristics are then used to determine how to record the multimedia at 130, or in the case of a message, how to retrieve the message from storage and deliver it to its intended recipients. The context may be determined as the conference session or monitoring session is occurring or before it begins based on information indicating the subject matter or topic of the session or the users associated with the said multimedia stream. The context of a message to be delivered to a recipient may be determined based on one or more words or phrases in the message as well as the particular source of the message, time of reception of the message relative to prior communication attempts, etc., as described hereinafter. Examples of the operations performed at 120 are described hereinafter in connection with FIG. 3.

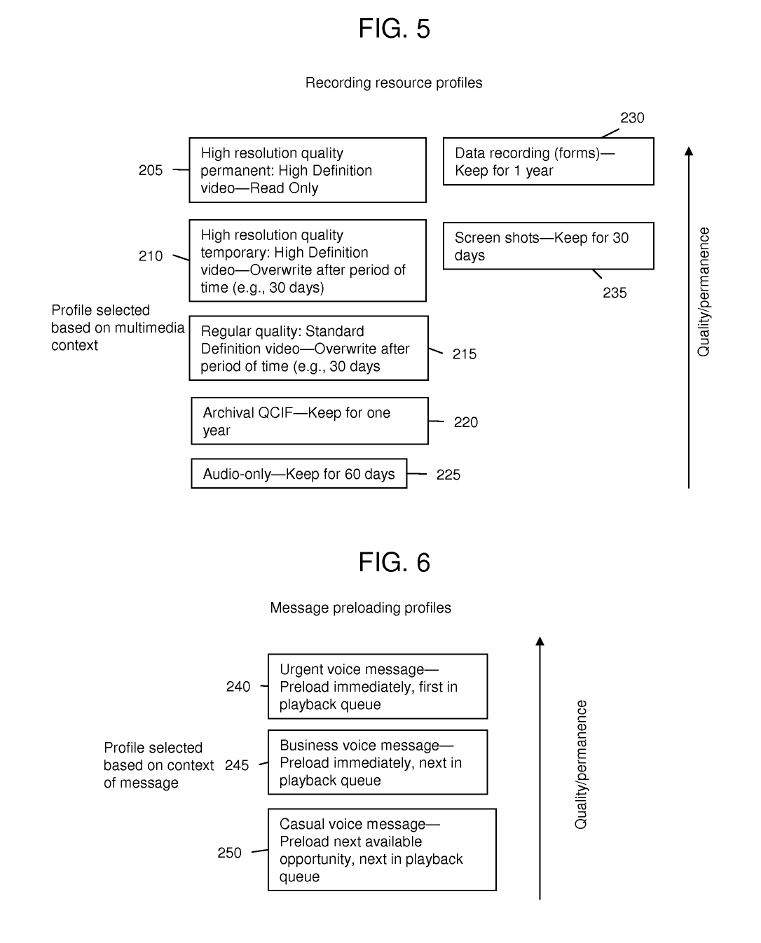

At 130, resources for the multimedia (for recording or transmitting a message) are allocated based on the amount of available resources as well as the context and associated usage policy rules or profiles. Examples of the usage policy rules or profiles are described hereinafter in connection with FIGS. 5 and 6. Generally, the usage policy rules state that a certain set of resource parameters are determined for a given context and also based on the recording resources available at that time. In other words, the context determines the resources (and related parameters thereof) that are allocated. For example, allocation of recording resources is made according to a resolution quality for recording the multimedia and allocation of storage resources according to a storage permanency for the multimedia. Recording resources and storage resources are allocated according to one of a plurality of recording and storage profiles that determine a quality of a recording to be made for the multimedia and a permanency of the storage resources to be used for the storage of the recording of the multimedia. The context may indicate a relative priority of the multimedia to be recorded. The allocation of recording resources is made such that higher priority multimedia is allocated with higher quality recording resources and more permanent storage resources and lower priority multimedia is allocated with lower quality recording resources and less permanent storage resources. Moreover, the context of the session may change as the session progresses and it is envisioned that the resources used to record the multimedia for the session may be changed to different recording resources when a change in context is detected. Furthermore, the resource control server 70 is optionally configured to monitor utilization of the resources.

Reference is now made to FIG. 4. FIG. 4 shows a flow chart that depicts examples of determining a context (operation 120 in FIG. 3) associated with a request to use resources. Depending on the nature of the session to be recorded (or the message to be retrieved from storage and delivered) the context may be determined in various ways. In the case where the session to be recorded is a conference session, at 122, the context can be determined from the identities of the participants involved in the conference session and/or from the meeting invitation associated with the conference session. The identities referred to here may be specific identifies of the persons or their role and/or relative position within an organization. To this end, the resource control server 70 may refer to the identification server 65 to obtain corporate roles and relative positions of persons involved in a conference session. For example, a session involving a Vice President may be given higher priority to access to use resources than a session involving only members of an engineering development team. Thus, the context may be determined by determining positions in an organization, e.g., a company, of participants in the conference session. Moreover, at 122, a subject line of a meeting invitation may contain certain words or phrases that reveal the topic of the meeting. For example, a “Strategy” meeting may have a different level of importance and priority than a “Bug Fix” meeting.

At 124, the context for a conference session is determined from analytics of the multimedia for the conference session. Operation 124 has many variations. First, the context may include subject matter or topic of the conference session as well as tone or mood of the conference session. The topic/subject matter of the conference session may be fixed or may change during the conference session. Likewise, the tone or mood of the conference session may change during the conference session. There are numerous ways to determine the context of the conference session as it is occurring using real-time analytics of the multimedia from the conference session. For example, audio analytics may be performed on the conference session audio (conversations of the participants) to detect for certain words or phrases that reveal the topic(s) of the meeting. In another example, text analytics is performed on documents shared during the meeting, text messages exchanged or on-line chat sessions conducted during the meeting. In still another example, a tone or mood of the meeting may be determined from conference audio (to detect contentious or anger tones) and also from video analysis of the conference video to detect one or more gestures indicative of the tone or mood of one or more persons during the meeting. In general, one or more particular words in the multimedia associated with a conference session may be used to determine the context of the multimedia associated with the conference session Likewise, one or more gestures of a participant in the conference session may be detected from the multimedia associated with the conference session using video analytics to determine the context of the multimedia for the conference session.

At 126, the context of a multimedia stream from a monitoring endpoint 12(1)-12(L) is determined from analytics of the multimedia obtained by a monitoring endpoint. The context for a multimedia stream from a monitoring endpoint may comprise the subject matter as well as the tone or mood. For example, when the monitoring endpoint is a video/audio surveillance device at a particular site, e.g., a bank, the audio of the multimedia stream for that endpoint is monitored to detect certain words such as “hold up” or “robbery” so that an appropriate allocation to recording resources is made for that multimedia stream. Similarly, when the monitoring endpoint is monitoring an emergency call center, then the context is always set to a high priority in order to record and permanently store a relatively high resolution recording of the calls. In the case of a customer service call center, the audio is monitored to detect for certain words that indicate customer dissatisfaction, such as “transfer my account” or “emergency” or other negative tones in the conversation, an appropriate context is assigned to that call so that it is recorded properly for later reference. In another example, any call that involves a person in the Human Resources department of a company is always assigned a certain context profile so that it is given a corresponding priority to the recording resources. Still in the call center field, the data (text) entered into forms by a call center agent is assigned a context profile that is perhaps different from a video screen shot stream of the entry of that data by a call center agent. In still another example, video analytics are made for a video stream obtained from a monitoring endpoint to detect when a violent event occurs, such as an explosion or fire, such that the recording resources allocated to record that video stream (prior to and after the violent event) are stored in a highly secure and permanent manner for later reference. Thus, the context for multimedia from a monitoring endpoint may be determined by detecting one or more particular words contained in multimedia captured by the monitoring endpoint, such as from a call to a call center or from multimedia captured by a surveillance camera.

At 128, the resource control server 70 analyzes messages as they are retrieved from storage to be delivered to a destination mobile device to determine the context of the message. For example, the resource control server 70 analyzes audio of a voice message, words in a text message, video in a video message to determine gestures in the video message, and/or graphics of the message ultimately to determine a relative importance of the message (e.g., urgency of the message). In addition, the resource control server 70, through communications with the mobile service provider server 42, determines the number of prior attempts from a particular caller to reach the user of the destination mobile device. Using the context of the message and information about the number of prior attempts, the resource control server 70 can assign a context (priority) to the message for its delivery. For example, a higher priority is assigned for delivery of the message when the message is determined to contain indications of urgency (words such as “it's urgent you call me” or “emergency”, etc.) coupled with knowledge of several prior attempts to reach that user. By contrast, when a recorded message is to be a retrieved and delivered that does not contain any indications of urgency and there is no information indicating prior attempts by that caller to reach that party, then a lower priority is assigned for delivery of that message.

Still referring to FIG. 4, after the context of the multimedia to be recorded is determined, at 129 metadata for the multimedia is generated for storage with the multimedia. Whether or not any metadata is generated for the multimedia and the amount of metadata generated depends on the context determined for the multimedia. The metadata may include summary information describing the nature of the multimedia, such as date, time, parties involved, subject matter, etc. When the context of the multimedia indicates that it is relatively low priority or exhibits other characteristics suggesting the metadata is relatively unimportant, or will be stored for a relatively short period of time and likely not referred to again, then no metadata may be generated for storage with the recording. On the other hand, when the context indicates that the multimedia is relatively high priority, will be stored for a relatively long period of time and is likely to be accessed at a later time, then metadata is generated for storage with the recording of the multimedia. For example, conference sessions involving Vice Presidents of a company may always have metadata generated for them to indicate the date, time, participants involved, subject matter, etc., for storage with the recording.

Reference is now made to FIG. 5. In one form, the resource control server 70 stores data or has access to data representing a set of “canned” or fixed resource profiles. Examples of these profiles are shown in FIG. 5 and listed below.

1. High resolution quality permanent profile 205. Useful for High Definition (HD) video and stored in a Read-Only form so that it cannot be overwritten. The data is stored at a high resolution quality and in a permanent storage, e.g., archival data storage 82 in FIG. 1.

2. High resolution quality temporary profile 210. Useful for HD video, but can be overwritten after a period of time, e.g., 30 days. The data is stored at a high resolution quality and in a temporary storage, e.g., data storage 84 in FIG. 1.

3. Regular quality profile 215. Useful for Standard Definition (SD) video, but the data can be overwritten after a period of time, e.g., 30 days.

4. Archival Quarter Common Intermediate Format (QCIF) profile 220. Useful for QCIF video. Storage is on permanent storage unit, e.g., data storage 82, and is kept for a period of time, e.g., one year.

5. Audio-only profile 225. Useful for audio only and stored for a period of time, e.g., 60 days.

6. Data recording (forms) profile 230. Useful for recording data stored into forms, e.g., by a call center agent. Storage is in a permanent form and kept for a relatively long period of time, e.g., one year.

7. Screen shots profile 235. Useful for screen shot video, e.g., at a call center. Storage is for a relatively short period of time, e.g., 30 days.

When the resource control server 70 is to allocate resources in response to a request, in general it selects the highest profile determined by the policy rules provided resources are available at that time to support that profile. Otherwise, the next highest resources profile is used. In other words, the context determined for the multimedia may be assigned a context type among a hierarchy of a plurality of context types and the allocation of resources is made based on a recording and storage profile assigned to a corresponding context type.

The following are some examples:

A 911 emergency calls is recorded using the High-resolution permanent profile.

A conference session, where one participant has a title of Vice President or higher, is recorded using a High-resolution temporary profile.

Calls to a call center are recorded using the Regular quality profile.

A conference call where one participant is from Human Resources is recorded using the Archival profile.

A conference call concerning financial trading matters is recorded using the Archival profile.

Conference sessions involving attorneys and their clients are recorded using the Archival profile.

Internal team conference calls are recorded using the Audio-only profile.

A call to a call center that contains the words “emergency” or “fire” are recorded using the High-resolution permanent profile.

A call to a call center in which analytics determine upset or negative customer sentiment is recorded using the High resolution temporary profile.

Detection of particular words (keywords) may be combined with deployment-specific or contextual details. For example, the keyword “risk” in a financial trading related call will be interpreted different from an internal team meeting. Contextual details can be gleaned from participant corporate directory information, call information, analytics or by manual assigning a context to a particular session to be recorded.

As explained above, the recording resources allocated for a session may be initially assigned at one profile level, but during the session, circumstances and consequently the context changes, to warrant a change in the recording resources used for that session. For example, a monitoring endpoint for a security site, e.g., a bank, may be initially assigned to the regular quality profile and when a keyword is detected in the audio from that monitoring endpoint, such as “hold up”, the resource control server 70 detects this and changes the recording profile to the high resolution quality permanent profile. In other words, the resource control server 70 automatically increases the amount of resources allocated to record that stream to record higher definition video or audio for later better recognition. In another variation, the recording for such an event is marked as “undeletable” and “un-modifiable” to ensure that in systems with limited storage this critical information is not overwritten. It should be noted that in accordance with one embodiment, the media is always recorded at the highest quality and then only at the end of the recording session before committing the recording to storage, the system determines the proper parameters and converts the media to the final quality/resolution format for storage.

The policy rules for resource allocation may be a multi-layered set of rules, with some default rules, and others defined by the enterprise, a group or individual users. For example, the resource control server 70 can be deployed with a basic set of profiles and rules (stored in the policy server 90, with progressive refinement to these rules made depending on user and other input. Thus, the policy rules may be tuned for optimal performance over time, rather than needing to be perfect the first time they are deployed. Thus, the rules may be deployed and thereafter adjusted incrementally to more closely map to user requirements as more rules are added or analytics information is available rather than a using fixed algorithm to allocate resources. The policy data may be stored in the policy server 90 or in any other storage attached to the network 30 to which the policy server 90 has access.

Reference is now made to FIG. 6, also with reference to FIG. 1. As explained above, mobile devices or other resource-constrained endpoints need to download messages from a server on demand and cannot retain the entire contents of a user's voice mail or video message account. One way to reduce the delay in playback is to retrieve and cache just the first few seconds of the messages on the mobile device before the user actually requests playback. If/when the user requests playback for a specific message, the mobile device can begin playing the cached message content immediately while simultaneously starting retrieval of the remainder of the message content.

When the user's account contains many messages, it would not be desirable to preload all of them simultaneously, especially in a low bandwidth mobile (wireless) environment. Thus, the challenge is to prioritize the messages for preload.

Accordingly, the resource control server 70 is configured to use heuristics to predict which messages the destination mobile device user is likely to play back first (or more generally, next) and use that information to prioritize messages for preload, that is, for transmission to the mobile device. The functions of the resource control server 70 for this message delivery technique may be integrated into a voice mail server used by a mobile service provider.

As explained above, the resource control server 70 performs content audio or video analysis on the message to detect any indication of the urgency of the message or of the sender (e.g., stress level of the sender) of the message, or based on analytics on web forms. Call center agents may enter alphanumeric characters into web forms as part of their interaction with customers. The resource control server 70 analyzes these forms to allocate recording resources based on the data entered into these forms. The retrieved and played message may be an audio voice message, a video message, or forms, e.g., a web form such as those used by call center agents to enter/capture information from callers. Transmission resources and a transmit sequence position are allocated to preload the message to a mobile device associated with the intended recipient (e.g., the user of the destination mobile device 50 in FIG. 1). There may be several message loading resource profiles, one of which is selected by the resource control server 70 depending on the context determined for the message. A message that is determined to be urgent is preloaded immediately (transmit sequence position is first) and it is placed first in the playback queue in the destination mobile device. When the sender of the message sounds angry or is in a panic (implying that the message is urgent) then the resource control server 70 assigns a context to the message with a higher priority for preload, i.e., transmission sequence position, to the destination mobile device 50. An example of a profile for a message with an urgent context is shown at 240 in FIG. 6.

A message that is determined to be a business related message is placed immediately or perhaps with a lesser priority than an urgent message, and is placed “next”, but not first, in the playback queue in the destination mobile device. An example of a profile for a message with this type of context is shown at 245 A message that is determined to be “casual” is preloaded at the next available opportunity, that is, when bandwidth is more readily available, and is placed next in the playback queue in the destination mobile device. The profile for more casual messages is shown at 250.

In addition, the resource control server 70 may also analyze the number of times a caller has tried to contact the intended recipient in the last x number of minutes. When the same caller (using caller ID or enterprise directory information) has made several (at least n) communication attempts in x minutes, the resource control server 70 determines that the caller is urgently trying to reach the message recipient and elevates the priority of the most recent message. The resource allocation server may use a combined score of the stress analysis of the message along with a score representing n communication attempts in x minutes to determine if it should automatically preload that particular message to the mobile device. Thus, the resource control server 70 predicts which voice messages the user is likely to playback first and automatically allocates the resources to preload those messages to the intended recipient's mobile device.

The above description is intended by way of example only.

What is claimed is:

1. A method comprising:
receiving a request associated with multimedia for use of resources;
determining a context associated with the multimedia; and
allocating resources to be used for the multimedia based on the context.

2. The method of claim 1, wherein allocating comprises allocating recording resources according to a resolution quality for recording the multimedia and allocating storage resources according to a storage permanency for the multimedia.

3. The method of claim 2, wherein determining comprises generating a context indicating a relative priority of the multimedia to be recorded and allocating comprises allocating recording resources and storage resources such that higher priority multimedia is allocated with higher quality recording resources and more permanent storage resources and lower priority multimedia is allocated with lower quality recording resources and less permanent storage resources.

4. The method of claim 2, wherein allocating comprises allocating recording resources and storage resources according to one of a plurality of recording and storage profiles that determine a quality of a recording to be made for the multimedia and a permanency of the storage resources to be used for the storage of the recording of the multimedia.

5. The method of claim 4, wherein determining the context of the multimedia comprises generating a context type among a hierarchy of a plurality of context types, and allocating comprises allocating a resources based on a recording and storage profile assigned to a corresponding context type.

6. The method of claim 1, wherein determining the context comprises determining a topic of a conference session between multiple meeting participants, and wherein the multimedia comprises one or more of audio, video, text and graphics.

7. The method of claim 6, wherein determining the context comprises detecting one or more particular words in the multimedia associated with the conference session.

8. The method of claim 6, wherein determining the context comprises detecting one or more gestures of a participant in the conference session from the multimedia associated with the conference session.

9. The method of claim 6, wherein determining comprises determining positions in an organization of participants in the conference session.

10. The method of claim 1, wherein determining the context comprises detecting one or more particular words contained in multimedia captured by a monitoring endpoint from a call or from multimedia captured by a surveillance camera.

11. The method of claim 1, wherein the multimedia is a recorded message that is to be delivered to an intended recipient, and wherein determining the context comprises analyzing audio, video, text and/or graphics of the message to determine a relative importance of the message, and wherein allocating comprises allocating transmission resources and a transmit sequence position to preload the message to a remote device associated with the intended recipient of the message.

12. The method of claim 11, wherein determining the context comprises determining how many prior attempts have been made by a party to deliver the message to the intended recipient.

13. The method of claim 1, wherein allocating comprises allocating recording resources based on the context and recording resource availability at the time that the multimedia is to be recorded.

14. The method of claim 1, and further comprising, depending on the context, generating metadata comprising summary information of the multimedia, wherein the metadata is for storage with a recording of the multimedia.

15. The method of claim 1, and further comprising detecting a change in the context of the multimedia, and wherein allocating comprises allocating different recording resources for the multimedia based on the detected change in context.

16. A computer-readable memory medium storing instructions that, when executed by a processor, cause the processor to:
receive a request associated with multimedia for use of resources;
determine a context associated with the multimedia; and
allocate resources to be used for the multimedia based on the context.

17. The computer-readable memory medium of claim 16, wherein the instructions that cause the processor to allocate comprises instructions that cause the processor to allocate recording resources according to a resolution quality for recording the multimedia and to allocate storage resources according to a storage permanency for the multimedia.

18. The computer-readable memory medium of claim 16, wherein the instructions that cause the processor to allocate comprises instructions that cause the processor to allocate recording resources and storage resources according to one of a plurality of recording and storage profiles that determine a quality of a recording to be made for the multimedia and a permanency of the storage resources to be used for the storage of the recording of the multimedia.

19. The computer-readable memory medium of claim 16, wherein the instructions that cause the processor to determine the context comprise instructions that cause the processor to detect one or more particular words or one or more gestures in the multimedia.

20. The computer-readable memory medium of claim 16, wherein when the multimedia is a message to be delivered to an intended recipient, the instructions that cause the processor to determine comprise instructions that cause the processor to determine a relative importance of the message, and wherein the instructions that cause the processor to allocate comprise instructions that cause the processor to allocate transmission resources and a transmit sequence position to preload the message to a remote device associated with the intended recipient of the message.

21. An apparatus comprising:
a network interface unit configured to receive multimedia to be recorded;
a processor configured to be coupled to the network interface unit, wherein the processor is configured to:
receive a request associated with multimedia for use of resources;
determine a context associated with the multimedia; and
allocate resources to be used for the multimedia based on the context.

22. The apparatus of claim 21, wherein the processor is configured to allocate recording resources according to a resolution quality for recording the multimedia and to allocate storage resources according to a storage permanency for the multimedia.

23. The apparatus of claim 21, wherein the processor is further configured to determine the context by detecting one or more particular words or one or more gestures in the multimedia.

24. The apparatus of claim 21, wherein when the multimedia is a message to be delivered to an intended recipient, the processor is configured to determine a relative importance of the message, and to allocate transmission resources and a transmit sequence position to preload the message to a remote device associated with the intended recipient of the message.
